(19) United States
(12) Patent Application Publication
(10) Pub. No.: US 2026/0160972 A1
(43) Pub. Date: Jun. 11, 2026

(54) THERMALLY STABILIZED OPTICAL SYSTEM

(71) Applicant: Owl Labs, Inc., Somerville, MA (US)

(72) Inventors: Sara Nagelberg, Vancouver (CA); Susan Rico, Long Beach, CA (US); Wei-Ting Chiu, Zhubei City (TW); Wei Chih Hung, Zhubei City (TW); Jacob Na, Monte Sereno, CA (US); Fabian Ramirez, Richmond, CA (US); Maksim Makeev, Somerville, MA (US); Mark S. Schnittman, Somerville, MA (US)

(21) Appl. No.: 19/180,051

(22) Filed: Apr. 15, 2025

Related U.S. Application Data
(60) Provisional application No. 63/635,291, filed on Apr. 17, 2024.

(51) Int. Cl. G02B 7/02; G02B 1/04; G02B 13/00; G02B 27/00

(52) U.S. Cl. CPC G02B 7/028; G02B 1/041; G02B 7/025; G02B 9/12; G02B 9/64; G02B 13/0045; G02B 13/006; G02B 13/04; G02B 13/06; G02B 27/0018

(57) ABSTRACT

Fixed focal length, wide angle lens that maintains its effective focal length and imaging quality with change in temperature

### RELATED APPLICATIONS

This application claims the benefit of priority of U.S. Provisional Application No. 63/635,291, filed on Apr. 17, 2024, the entire contents of which application(s) are incorporated herein by reference.

### FIELD OF THE INVENTION

The present invention relates generally to an optical system for use in the visible spectrum from 430 nm-650 nm, and more particularly to a wide angle, fixed focal length lens that maintains its effective focal length and imaging quality with change in temperature.

### BACKGROUND OF THE INVENTION

The ability to focus light to create high quality images can be particularly difficult as the field of view (FOV) is greatly increased, such as up to 210 degrees full field. (As used herein “light” is defined to mean the visible spectrum from 430 nm-650 nm.) More difficult is maintaining acceptable lens performance in an environment where the temperature changes. Yet an added challenge is doing so while focusing on an image sensor with a high CRA, which is more common in the current market of high resolution image sensors, most often optimized for small form factor mobile applications. Accordingly, it would be an advance in the state of the art to provide a wide angle, fixed focal length lens, high CRA lens that maintains its effective focal length and imaging quality with change in temperature.

### SUMMARY OF THE DISCLOSURE

The present invention is concerned with solving the problem of providing a wide angle (i.e., full FOV of at least) 180°, fixed focal length lens that maintains its effective focal length and imaging quality with change in temperature in the expected operational environment, that is from 20° C. to 50° C. throughout the visible spectrum of 430 nm-650 nm.

As a solution to this problem, in one of its aspects the present invention may provide a temperature-stabilized wide angle lens system, having a fixed effective focal length, F, and having half field of view (FOV) of at least 90 degrees. The temperature-stabilized wide angle lens system may include a first lens group consisting of a first lens, a second lens and a third lens; a second lens group consisting of a fourth lens, a fifth lens, a sixth lens, and a seventh lens; and a third lens group consisting of an eighth lens, a ninth lens, and a tenth lens, the first through tenth lenses disposed in sequential order along an optical axis of the wide angle lens system from an object side to an image side thereof. The first through tenth lenses may cooperate to provide the fixed effective focal length, and the first through tenth lenses may be configured to: i) maintain F such that F changes by less than 1 micron over a temperature range of 20° C. to 50° C., and/or ii) have less than 1 micron of lateral color throughout a half field of view between 55 degrees and at least 90 degrees (e.g., 105 degrees) for all wavelengths of light between 430 nm-650 nm throughout the temperature range of 20° C. to 50° C., and/or iii) maintain an MTF at 156 lp/mm greater than 30% throughout a half field of view from 55 degrees to at least 90 degrees (e.g., 105 degrees) for all wavelengths of light between 430 nm-650 nm throughout the temperature range of 20° C. to 50° C., and/or iv) provide an f-number of 2.4 or less, whereby thermal stability of the wide angle lens system is achieved.

In addition, the first through tenth lenses may be configured to maintain F between 1.1832 mm and 1.1839 mm over a temperature range of 20° C. to 50° C., respectively. The half FOV may also be 105 degrees to provide full FOV is 210 degrees. The eighth and ninth lenses may be a cemented doublet, and the doublet and the fifth and sixth lenses may have a negative change in optical power due to an increase in temperature from 20° C. to 50° C. The fourth and tenth lenses may have a positive change in optical power due to an increase in temperature from 20° C. to 50° C. The first through third lenses and seventh lens may have a minimal change in optical power of less than 5.37×10⁻⁹/m in optical power due to a change in temperature from 20° C. to 50° C.

The first through tenth lenses may be mounted at their respective edges in a lens barrel made of a material having a coefficient of thermal expansion between 3.0×10⁻⁵ cm/cm/° C. to 5.0×10⁻⁵ cm/cm/° C., such as 4.5×10⁻⁵ cm/cm/° C.; the lens barrel may be made of a fiber glass reinforced polycarbonate.

The temperature-stabilized wide angle lens system may have less than 1 micron of lateral color throughout a half field of view between 55 degrees and 105 degrees for all wavelengths of light between 430 nm-650 nm throughout the temperature range of 20° C. to 50° C.

The MTF at 156 lp/mm may be greater than 30% throughout a half field of view from 55 degrees to 105 degrees for all wavelengths of light between 430 nm-650 nm throughout the temperature range of 20° C. to 50° C. The MTF at 156 lp/mm may be greater than 30% throughout a half field of view from 55 degrees to 105 degrees for all wavelengths of light between 430 nm-650 nm throughout the temperature range of 20° C. to 50° C.

The angle of a chief ray is about 31 degrees from normal measured at an image plane of the wide angle lens at 430 nm-650 nm throughout the temperature range of 20° C. to 50° C.

The lens system may have a flare ratio<1×10⁻⁵ where the flare ratio is an intensity of a ghost image at 430 nm-650 nm, created by internal reflections in the temperature-stabilized wide angle lens system, on the image plane divided by intensity of an image created by the temperature-stabilized wide angle lens system on the image plane throughout the temperature range of 20° C. to 50° C.

An obscuration may be disposed on an object-side surface of the second lens, the obscuration having a circular shape centered on the object-side surface and having a diameter that is 42% of the diameter of the second lens, whereby the obscuration blocks at least 90% of the light impinging on the obscuration to provide the flare ratio<1×10⁻⁵. The obscuration may be configured to block at least 90% the light disposed at half field of view of 43° or less from the optical axis from propagating through the temperature-stabilized wide angle lens system to provide the flare ratio<1×10⁻⁵.

The first through fourth lenses and tenth lens may each have negative optical power; the fifth through ninth lenses may each have positive optical power. The fourth, fifth and tenth lenses may be made from a plastic material, and the first through third lenses and sixth through ninth lenses may be glass.

All surfaces of the first through third, sixth, eighth, and ninth lenses may be spherical, and all surfaces of the fourth, fifth, seventh and tenth lenses may be aspherical.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates an exemplary configuration of a temperature-stabilized wide angle lens system in accordance with the present invention;

FIG. 2-13C illustrates various plots of the performance of the lens of FIG. 1;

FIG. 14 illustrates the CRA vs image height of the lens of FIG. 1; and

FIG. 15 schematically illustrates a cross-sectional view of the lens of FIG. 1 in a lens mount and holder.

### DETAILED DESCRIPTION OF THE INVENTION

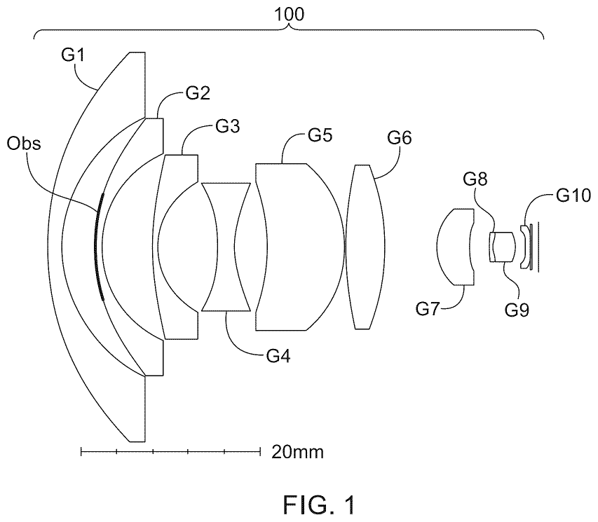

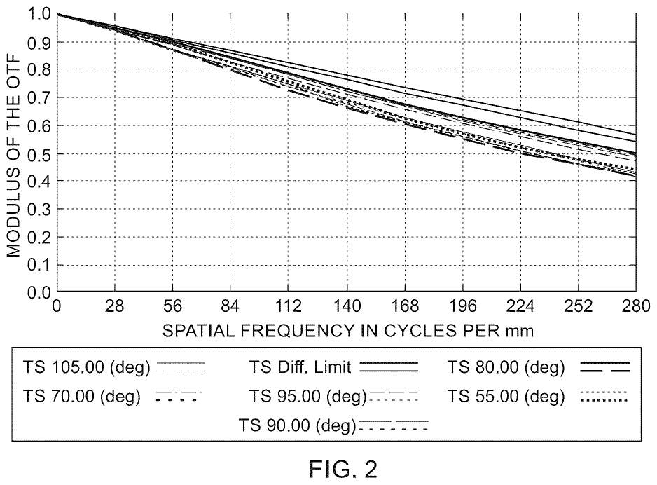

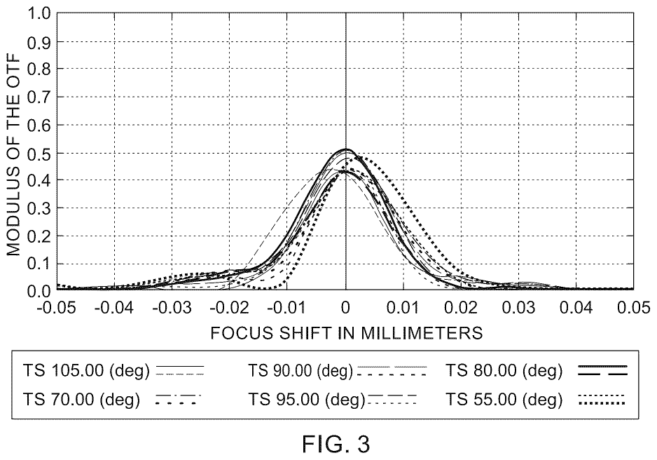

Referring now to the figures, wherein like elements are numbered alike throughout, FIG. 1 schematically illustrates a design in accordance with the present invention of a temperature-stabilized wide angle lens system 100 having 10 lenses G1-G10 disposed in sequential order on an optical axis, with object space to the left and image to the right in the drawing. The first order properties and lens prescription are provided in Tables 1-3.

The first three lenses G1-G3 are meniscus lenses with negative power to decrease the angle of light entering the wide angle lens system 100. These lenses are made of glass and have spherical surfaces. Lens G1-G3 are sufficiently resistant to change in optical power over a temperature range of 20° C. to 50° C., with a change in optical power of 5.37×10⁻⁹/m or less. Collectively, lenses G1-G3 may be considered as a first lens group.

A second lens group includes lenses G4-G7, with lenses G4 and G5 made of a cyclo olefin polymer and lenses G6 and G7 made from glass. Lens G6 has spherical surfaces and lenses G4, G5, and G7 have aspherical surfaces as set forth in Table 3 and equation 1. A third group of lenses includes lenses G8-G10, with the system stop disposed between the second and third lens groups. Lenses G8 and G9 are made of glass and lens G10 of a plastic polycarbonate resin. Lenses G8 and G9 are a cemented doublet having all spherical surfaces, while lens G10 has aspherical surfaces as set forth in Table 3 and equation 1.

Lenses G1-G10 cooperate to maintain the effective focal length, F, of the temperature-stabilized wide angle lens system 100 between 1.1832 mm and 1.1839 mm over a temperature range of 20° C. to 50° C., respectively. Lenses G4-G10 are further designed to have temperature changes that offset one another. For example, lenses G4 and G10 have a positive change in optical power due to an increase in temperature from 20° C. to 50° C., and lenses G5-G9 have a negative change in optical power due to an increase in temperature from 20° C. to 50° C. Together with the minimal change in optical power of lenses G1-G3 the temperature-stabilized wide angle lens system 100 attains less than 1 micron change in F over a temperature range of 20° C. to 50° C.

In addition, the temperature-stabilized wide angle lens system 100 has less than 1 micron of lateral color throughout a half field of view between 55 degrees and 105 degrees for all wavelengths of light between 430 nm-650 nm throughout the temperature range of 20° C. to 50° C. The temperature-stabilized wide angle lens system 100 also maintains an MTF at 156 lp/mm greater than 30% throughout a half field of view from 55 degrees to 105 degrees for all wavelengths of light between 430 nm-650 nm throughout the temperature range of 20° C. to 50° C.

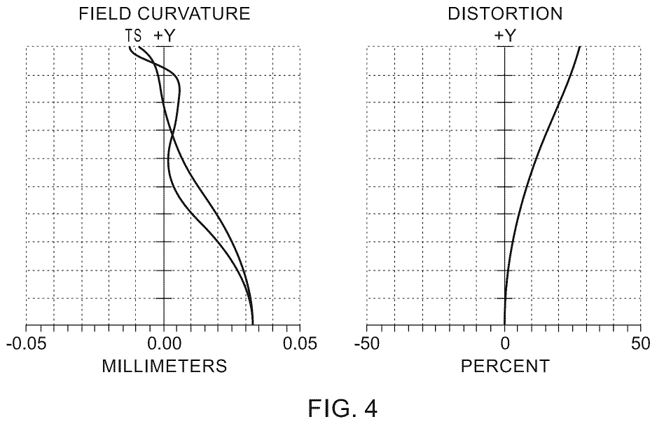

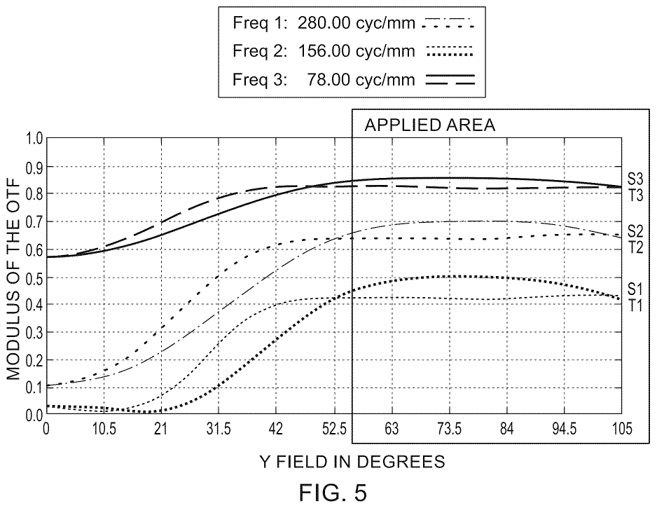

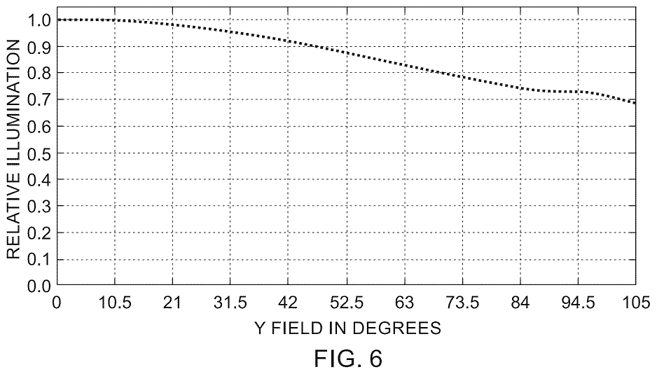

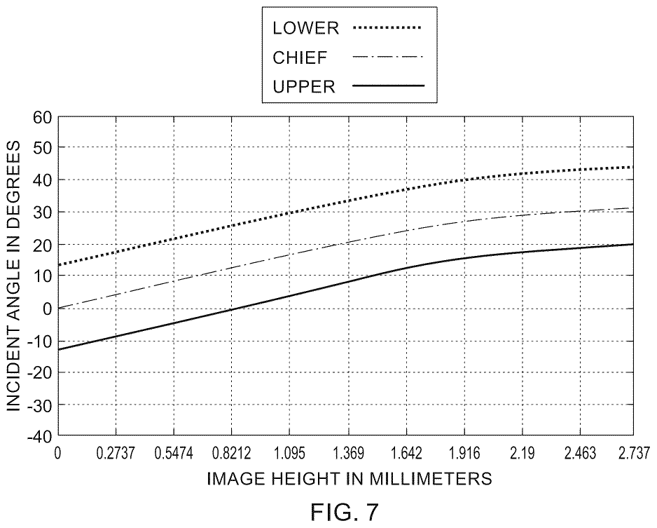

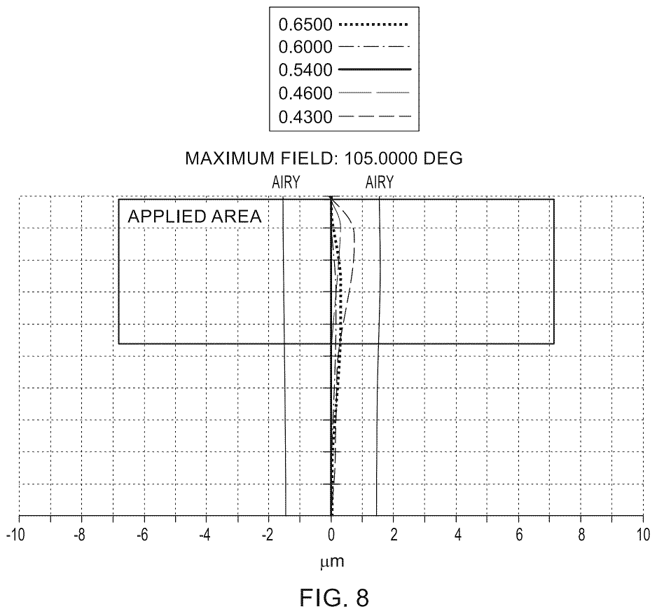

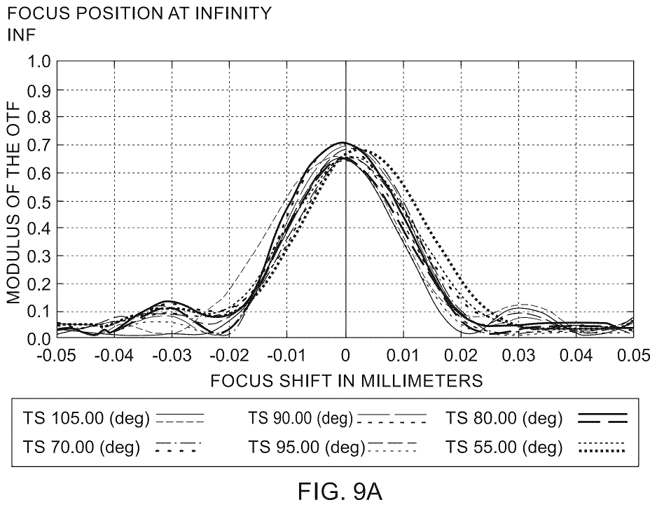

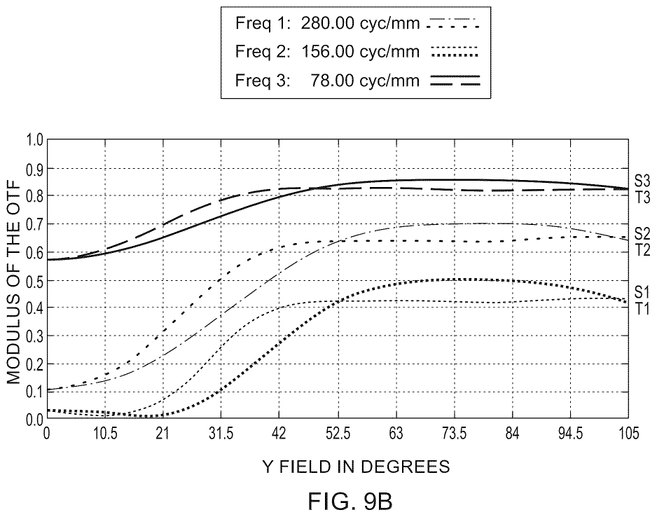

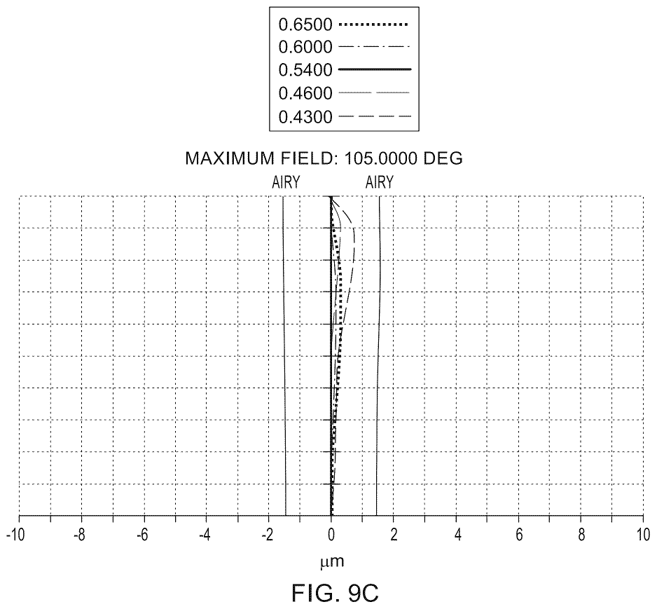

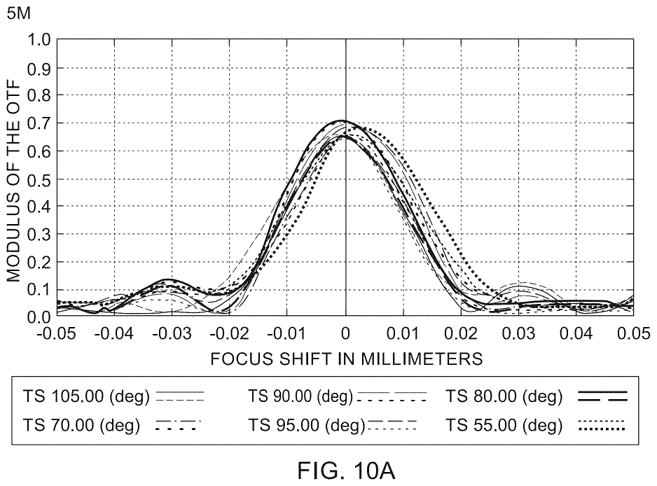

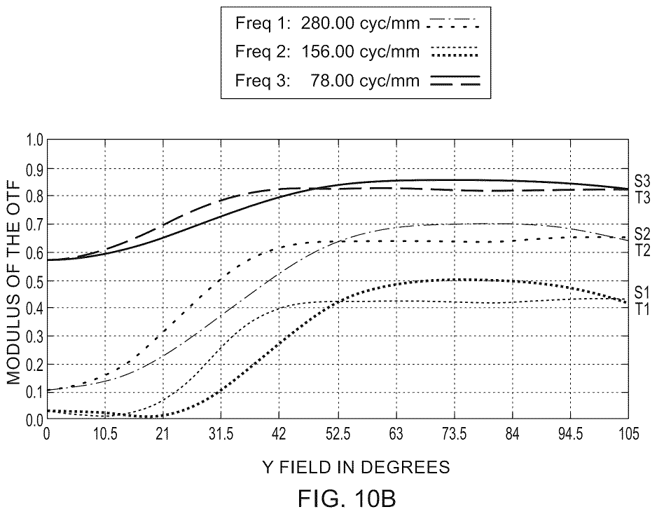

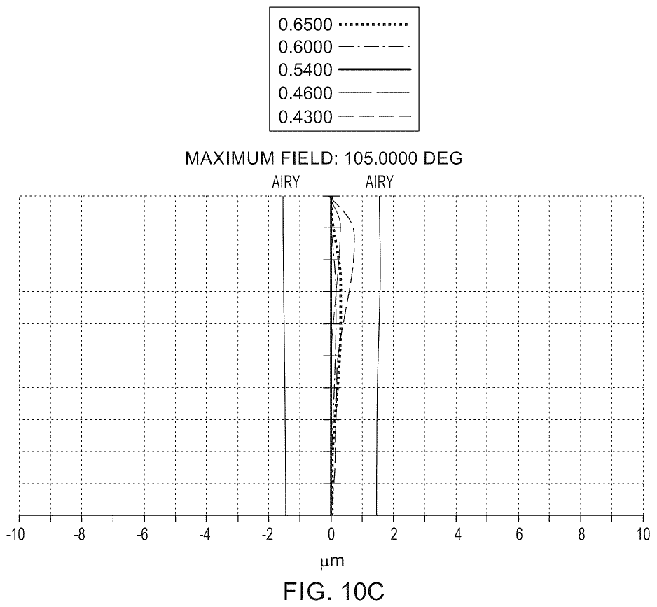

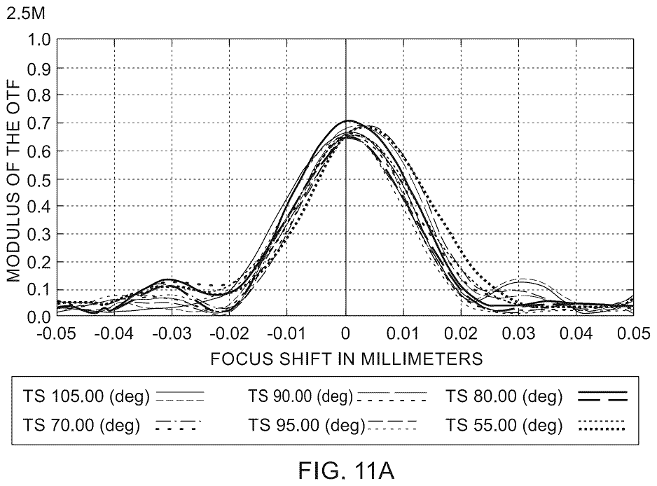

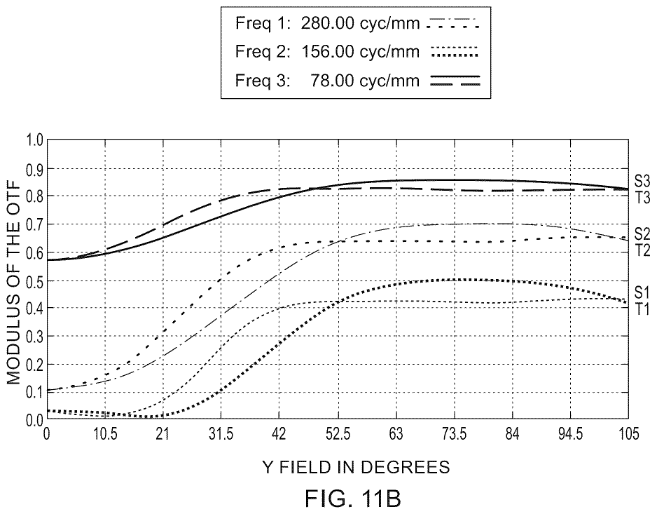

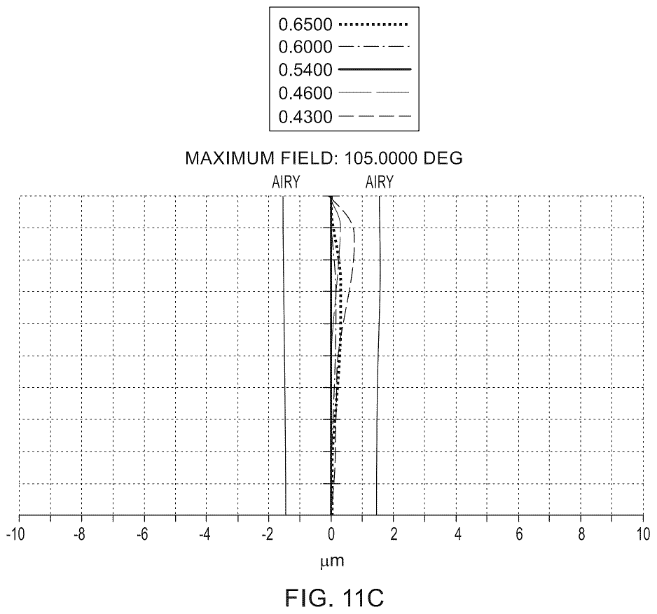

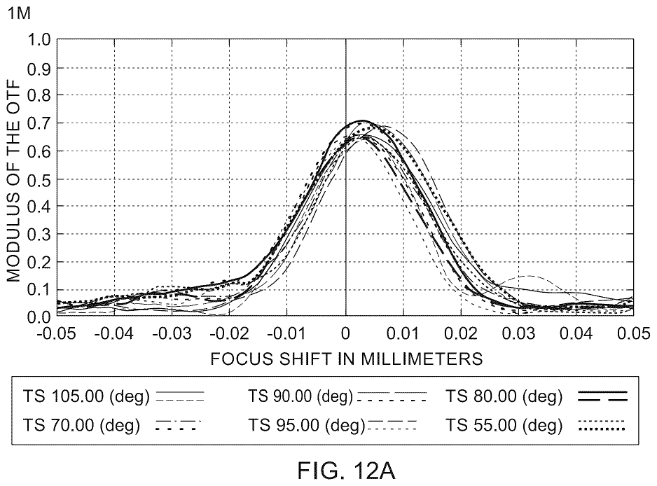

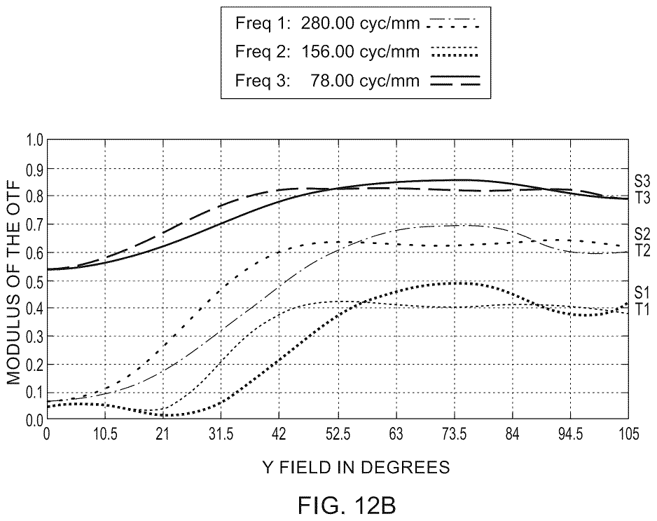

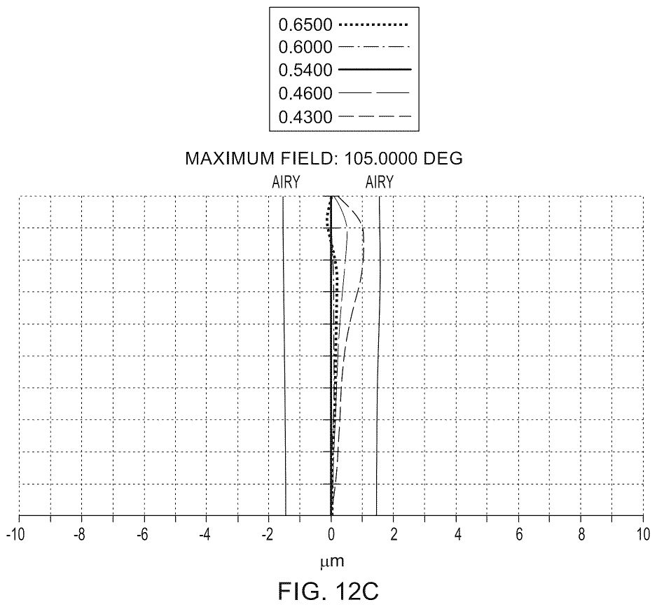

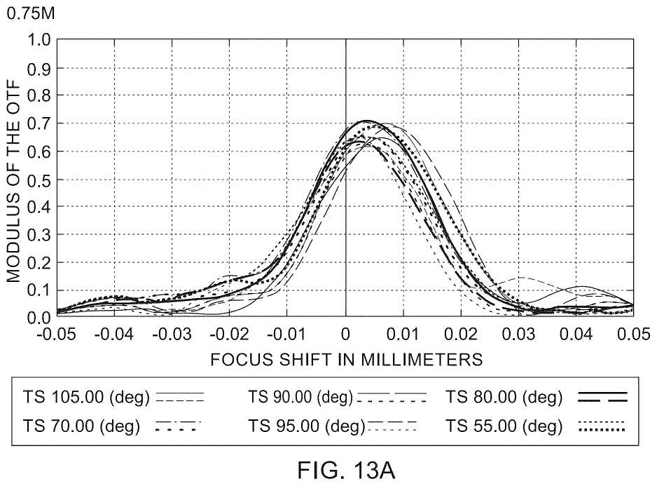

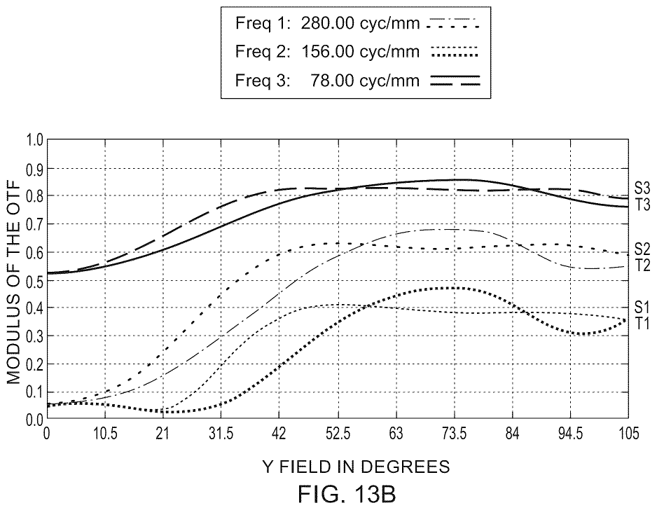

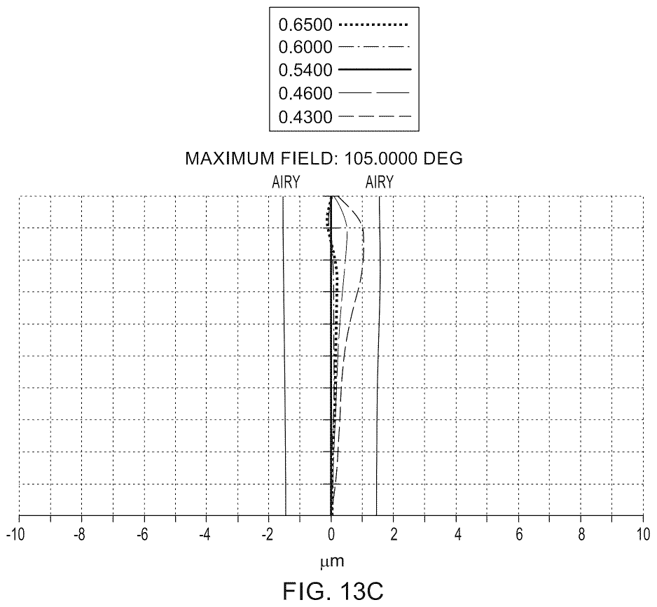

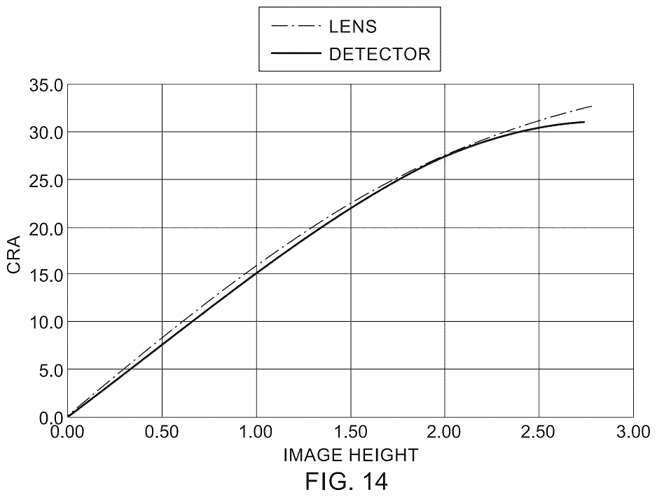

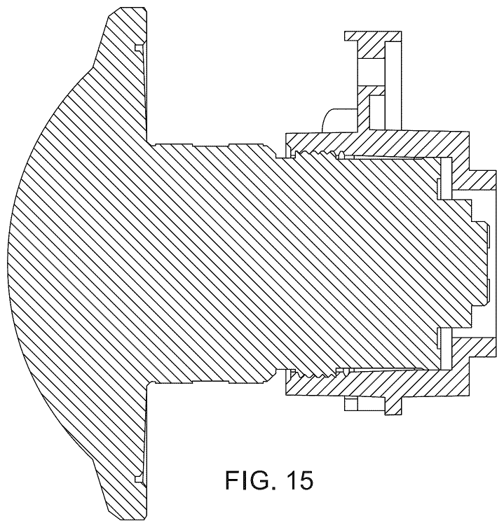

Further the lens mount barrel, FIG. 4, can contribute to the temperature stability of the lens system 100. The lenses G1-G10 can be mounted by their respective edges in a lens barrel made of a material having a coefficient of thermal expansion between 3.0×10⁻⁵ cm/cm/° C. to 5.0×10⁻⁵ cm/cm/° C., such as fiber glass reinforced polycarbonate.

Another feature of the temperature-stabilized wide angle lens system 100 is the ability to improve image quality by eliminating or reducing the presence of a ghost image at the image plane. A measure of the ability to reduce the ghost image is a flare ratio, where flare internal to the lens is responsible for the ghost image. The flare ratio is defined to be the ratio of the intensity of a ghost image on the image plane (created by internal reflections in the temperature-stabilized wide angle lens system 100) divided by the intensity of the image created by the temperature-stabilized wide angle lens system 100 on the image plane. The present design is able to achieve a flare ratio<1×10⁻⁵. To achieve this ratio, an obscuration “Obs” is placed on the object-side surface of lens G2, FIG. 1. The obscuration Obs has a 12 mm diameter circular shape centered on the object-side surface, which is 42% of the diameter of the lens G2, whereby the obscuration blocks at least 90% of the light impinging on the obscuration. Put another way the obscuration Obs is configured to block at least 90% of the light disposed at half field of view of 43° or less from the optical axis from propagating through the temperature-stabilized wide angle lens system 100.

TABLE 1
Lens specifications.

| Parameter | Value | |
|---|---|---|
| FOV | 105° half FOV, 210° full FOV | |
| Region of optimization | 55° half FOV to 105° half FOV | |
| Image sensor resolution | 9280 (H) × 6944 (V) pixels, 0.8 micron | |
| | pixel size | |
| EFL | 1.183 | mm |
| Image quality (MTF) | >30% throughout region of optimization for | |
| | 156 lp/mm | |
| Design wavelength | 430 nm-650 nm | |
| f-number | <2.4 | |
| Lateral color | <2 | microns |

| | |
|---|---|
| CRA | 31° |
| Stray light, flare ratio | <1 × 10⁻⁵ |
| Operating Temp Range | 20° C. to 50° C. |

TABLE 2
Lens prescription including surface type, spacing, and material,
where all glass material is from Hoya Corporation, with
the exception of D-K9 from CDGM Glass Company Ltd. D263Teco
is a Schott substrate for the IR filter. K26R is from Zeonex
Specialty Materials, Inc, and EP-6000 is from Mitsubishi
Gas Chemical Company. All dimensions in mm.

| | | | | | | Semi- |
|---|---|---|---|---|---|---|
| # | Type | Lens | Radius | Thickness | Material | Diameter |
| 2 | Spherical | G1 | 30.06 | 1.50 | TAC8 | 21.60 |
| 3 | Spherical | | 15.71 | 3.73 | | 14.40 |
| 4 | Spherical | G2 | 20.51 | 0.70 | TAFD5G | 14.23 |
| 5 | Spherical | | 11.48 | 5.79 | | 10.52 |
| 6 | Spherical | G3 | 42.67 | 0.50 | TAC8 | 10.30 |
| 7 | Spherical | | 8.07 | 6.63 | | 7.22 |
| 8 | EvenAsph | G4 | −18.19 | 1.98 | K26R | 7.08 |
| 9 | EvenAsph | | 11.58 | 3.57 | | 7.30 |
| 10 | EvenAsph | G5 | −24.86 | 8.75 | K26R | 7.46 |
| 11 | EvenAsph | | −12.28 | 0.06 | | 9.39 |
| 12 | Spherical | G6 | 38.88 | 4.41 | PCD51 | 9.23 |
| 13 | Spherical | | −24.07 | 5.82 | | 9.23 |
| 14 | EvenAsph | G7 | 5.47 | 3.67 | D-K9 | 4.19 |
| 15 | EvenAsph | | 12.21 | 2.19 | | 2.63 |
| 17 | Spherical | G8 | 5.86 | 0.40 | FDS90 | 1.00 |
| 18 | Spherical | G9 | 2.26 | 2.46 | FCD515 | 1.00 |
| 19 | Spherical | | −4.26 | 1.15 | | 1.64 |
| 20 | EvenAsph | G10 | 488.48 | 0.50 | EP-6000 | 1.93 |
| 21 | EvenAsph | | 7.58 | 0.06 | | 2.29 |
| 22 | Spherical | IR | Infinity | 0.21 | D263TECO | 2.43 |
| 23 | Spherical | | Infinity | 0.74 | | 2.47 |

TABLE 3
Surface prescription for aspheric components of non-spherical surfaces.

| | Conic | 4th order | 6th order | 8th order | 10th order | 12th order | 14th order | 16th order |
|---|---|---|---|---|---|---|---|---|
| Lens | (k) | (A4) | (A6) | (A8) | (A10) | (A12) | (A14) | (A16) |
| G4 | 3.56 | 1.29E−4 | −6.84E−6 | 2.39E−7 | −5.56E−9 | 4.50E−11 | 2.37E−13 | −2.19E−15 |
| | −1.30 | −2.76E−4 | 5.22E−6 | 2.26E−9 | −5.46E−9 | 1.11E−10 | −6.76E−13 | 9.26E−16 |
| G5 | 1.22 | −3.07E−5 | 8.15E−7 | 1.95E−9 | −8.67E−11 | −5.14E−12 | −1.29E−13 | 2.65E−15 |
| | 2.51E−2 | −3.05E−6 | 1.49E−7 | 2.13E−9 | 7.65E−13 | −1.28E−13 | −4.66E−17 | −1.48E−18 |
| G7 | −1.26E−1 | −3.08E−4 | 1.16E−5 | −1.99E−6 | 1.93E−7 | −3.01E−9 | −8.20E−11 | 5.73E−12 |
| | 1.42E+1 | −7.97E−4 | 2.63E−4 | −5.52E−5 | 8.44E−6 | −2.17E−7 | −4.06E−8 | 1.76E−9 |
| G10 | 0.00 | −3.36E−4 | −7.75E−4 | 6.39E−4 | −1.58E−4 | 4.08E−6 | 1.29E−6 | −3.10E−2 |
| | 8.07 | −2.07E−3 | 8.82E−4 | −1.72E−4 | 1.37E−5 | −1.26E−6 | 6.25E−8 | −2.42E−2 |

$$Z ( s ) = \frac{C {s}^{2}}{1 + \sqrt{1 - ( 1 + k ) {C}^{2} {s}^{2}}} + {A}_{4} {S}^{4} + {A}_{6} {S}^{6} + {A}_{8} {S}^{8} + {A}_{10} {S}^{10} + {A}_{12} {S}^{12} + {A}_{14} {S}^{14} + {A}_{16} {S}^{16} \qquad ( 1 )$$

where:
Z: sag of surface parallel to the optical axis
S: radial distance from the optical axis
C: curvature (1/R)
K: conic constant
A₄, A₆ . . . . A₁₆ are the 4^{th}, 6^{th}, . . . 16^{th} order aspheric coefficients.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims. cm What is claimed is:

1. A temperature-stabilized wide angle lens system, having a fixed effective focal length, F, and having half field of view (FOV) of at least 90 degree, the temperature-stabilized wide angle lens system comprising:
a first lens group consisting of a first lens, a second lens and a third lens;
a second lens group consisting of a fourth lens, a fifth lens, a sixth lens, and a seventh lens;
a third lens group consisting of an eighth lens, a ninth lens, and a tenth lens, the first through tenth lenses disposed in sequential order along an optical axis of the wide angle lens system from an object side to an image side thereof, and
wherein the first through tenth lenses cooperate to provide the fixed effective focal length, and the first through tenth lenses are configured to:
i. maintain F such that F changes by less than 1 micron over a temperature range of 20° C. to 50° C., and/or
ii. have less than 1 micron of lateral color throughout a half field of view between 55 degrees and 105 degrees for all wavelengths of light between 430 nm-650 nm throughout the temperature range of 20° C. to 50° C., and/or
iii. maintain an MTF at 156 lp/mm greater than 30% throughout a half field of view from 55 degrees to at least 90 degrees for all wavelengths of light between 430 nm-650 nm throughout the temperature range of 20° C. to 50° C., and/or
iv. provide an f-number of 2.4 or less,
whereby thermal stability of the wide angle lens system is achieved.

2. The temperature-stabilized wide angle lens system according to claim 1, wherein the first through tenth lenses are configured to maintain F between 1.1832 mm and 1.1839 mm over a temperature range of 20° C. to 50° C., respectively.

3. The temperature-stabilized wide angle lens system according to claim 1, wherein the half FOV is 105 degrees and full FOV is 210 degrees.

4. The temperature-stabilized wide angle lens system according to claim 1, wherein the fourth and tenth lenses have a positive change in optical power due to an increase in temperature from 20° C. to 50° C.

5. The temperature-stabilized wide angle lens system according to claim 1, wherein the eighth and ninth lenses comprises a cemented doublet, and wherein the doublet and the fifth and sixth lenses have a negative change in optical power due to an increase in temperature from 20° C. to 50° C.

6. The temperature-stabilized wide angle lens system according to claim 1, wherein the first through third lenses and seventh lens have change of less than 5.37×10⁻⁰⁹/m in optical power due to a change in temperature from 20° C. to 50° C.

7. The temperature-stabilized wide angle lens system according to claim 1, wherein the first through tenth lenses are mounted at their respective edges in a lens barrel made of a material having a coefficient of thermal expansion between 3.0×10⁻⁵ cm/cm/° C. to 5.0×10⁻⁵ cm/cm/° C.

8. The temperature-stabilized wide angle lens system according to claim 7, wherein the lens barrel is made of a fiber glass reinforced polycarbonate.

9. The temperature-stabilized wide angle lens system according to claim 1, wherein the temperature-stabilized wide angle lens system has less than 1 micron of lateral color throughout a half field of view between 55 degrees and 105 degrees for all wavelengths of light between 430 nm-650 nm throughout the temperature range of 20° C. to 50° C.

10. The temperature-stabilized wide angle lens system according to claim 1, wherein the temperature-stabilized wide angle lens system has less than 1 micron of lateral color throughout a half field of view between 55 degrees and 105 degrees for all wavelengths of light between 430 nm-650 nm throughout the temperature range of 20° C. to 50° C.

11. The temperature-stabilized wide angle lens system according to claim 1, wherein the MTF at 156 lp/mm greater than 30% throughout a half field of view from 55 degrees to 105 degrees for all wavelengths of light between 430 nm-650 nm throughout the temperature range of 20° C. to 50° C.

12. The temperature-stabilized wide angle lens system according to claim 1, wherein the MTF at 156 lp/mm greater than 30% throughout a half field of view from 55 degrees to 105 degrees for all wavelengths of light between 430 nm-650 nm throughout the temperature range of 20° C. to 50° C.

13. The temperature-stabilized wide angle lens system according to claim 1, wherein an angle of a chief ray is about 31 degrees throughout 430 nm-650 nm from normal measured at an image plane of the wide angle lens throughout the temperature range of 20° C. to 50° C.

14. The temperature-stabilized wide angle lens system according to claim 1, wherein the lens system has flare ratio<1×10⁻⁵ where the flare ratio is an intensity of a ghost image at 430 nm-650 nm, created by internal reflections in the temperature-stabilized wide angle lens system, on the image plane divided by intensity of an image created by the temperature-stabilized wide angle lens system on the image plane throughout the temperature range of 20° C. to 50° C.

15. The temperature-stabilized wide angle lens system according to 14, comprising an obscuration disposed on an object-side surface of the second lens, the obscuration having a circular shape centered on the object-side surface and having a diameter that is 42% of the diameter of the second lens, whereby the obscuration blocks at least 90% of the light impinging on the obscuration to provide the flare ratio<1×10⁻⁵.

16. The temperature-stabilized wide angle lens system according to 14, comprising an obscuration disposed on an object-side surface of the second lens, the obscuration having a circular shape centered on the object-side surface and configured to block at least 90% the light disposed at half field of view of 43° or less from the optical axis from propagating through the temperature-stabilized wide angle lens system to provide the flare ratio<1×10⁻⁵.

17. The temperature-stabilized wide angle lens system according to claim 1, wherein the first through fourth lenses and tenth lens each have negative optical power.

18. The temperature-stabilized wide angle lens system according to claim 1, wherein the fifth through ninth lenses each have positive optical power.

19. The temperature-stabilized wide angle lens system according to claim 1, wherein the fourth, fifth and tenth lenses are made from a plastic material.

20. The temperature-stabilized wide angle lens system according to claim 1, wherein the first through third lenses and sixth through ninth lenses are glass.

21. The temperature-stabilized wide angle lens system according to claim 1, wherein the eighth and ninth lenses are a cemented doublet.

22. The temperature-stabilized wide angle lens system according to claim 1, wherein all surfaces of the first through third, sixth, eighth, and ninth lenses are spherical.

23. The temperature-stabilized wide angle lens system according to claim 1, wherein all surfaces of the fourth, fifth, seventh and tenth lenses are aspherical.

24. The temperature-stabilized wide angle lens system according to claim 1, wherein the f-number is less than 2.4.
